(19) United States
(12) Patent Application Publication
(10) Pub. No.: US 2010/0255975 A1
(43) Pub. Date: Oct. 7, 2010

(54) POWDER RECOVERING DEVICE OR POWDER SPRAY COATING APPARATUS

(75) Inventors: Felix Mauchle, Abtwil (CH); Mark Steinnemann, Hofstetten (CH)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ITW GEMA AG, St. Gallen (CH)

(21) Appl. No.: 12/523,060

(22) PCT Filed: Jan. 22, 2008
(86) PCT No.: PCT/IB08/00139

§ 371 Date: Jul. 14, 2009

(30) Foreign Application Priority Data
Feb. 2, 2007 (DE) 10 2007 005 312.8

(51) Int. Cl. B04B 11/06; B04B 15/00; B04B 11/04; B05B 15/12

(52) U.S. Cl. 494/2; 494/56; 494/23; 494/10

(57) ABSTRACT

A powder spraycoating facility's powder recovery unit comprising a cyclone separator to separate coating powder from an air-powder mixed flow. The cyclone separator comprises a cyclone section separating powder from the powder-air mixed flow and a supply bin in the form of a downward-projecting extension of the cyclone section, said unit further comprising a powder passage in said cyclone from the cyclone section into the supply bin, said passage being devoid of powder blocking elements while being powder-tight relative to the atmosphere.

The present invention relates to a powder recovering device—hereafter powder recovery unit—used in a powder spraycoating apparatus—hereafter powder spraycoating facility—defined in the preamble of claim 1.

### STATE OF THE ART

U.S. Pat. No. 3,918,641 and DE 42 39 496 A1 each disclose a powder spraycoating facility fitted with a powder recovery unit.

EP 0 412 289 B1 shows an electrostatic powder spraycoating system comprising a powder pump in the form of an injector. In this injector, conveying compressed air causes a partial vacuum and thereby aspirates coating powder out of a powder container into the flow of conveying compressed air.

The flow of conveying compressed air moves the coating powder it contains to a sprayer. Furthermore DE 103 53 968 A1 shows a coating powder conveying system containing a tubular membrane pump conveying coating powder.

### DESCRIPTION OF THE INVENTION

The objective of the present invention is to resolve the problem of creating a novel powder recovery unit appropriate for various applications.

This problem is solved by the present invention by the features of claim 1.

Accordingly the present invention relates to a powder recovery unit used in a powder spraycoating facility and containing a cyclone separator fitted with a powder intake for a powder-air mixture, with a powder outlet for recovery powder from the mixed flow, and an airflow outlet for the air from the said mixed flow; characterized in that the cyclone separator comprises a cyclone section fitted with said powder intake and designed for cyclone action to separate recovery powder from the mixed flow; in that the cyclone separator comprises a supply bin in the form of a downward extension of the cyclone section and is fitted at its lower end with said powder outlet; in that said powder outlet is fitted with a powder outlet valve whereby, when the valve is closed, recovery powder which is separated in the cyclone section due to the cyclone effect from the mixed flow can be stored in the supply bin; a powder passage allowing moving powder from the cyclone section into the supply bin, said feedthrough being devoid of powder blocking elements but being powder-tight relative to the atmosphere.

Further features of the present invention are defined in the dependent claims.

The present invention is elucidated in illustrative manner by preferred embodiment modes and in relation to the appended drawings.

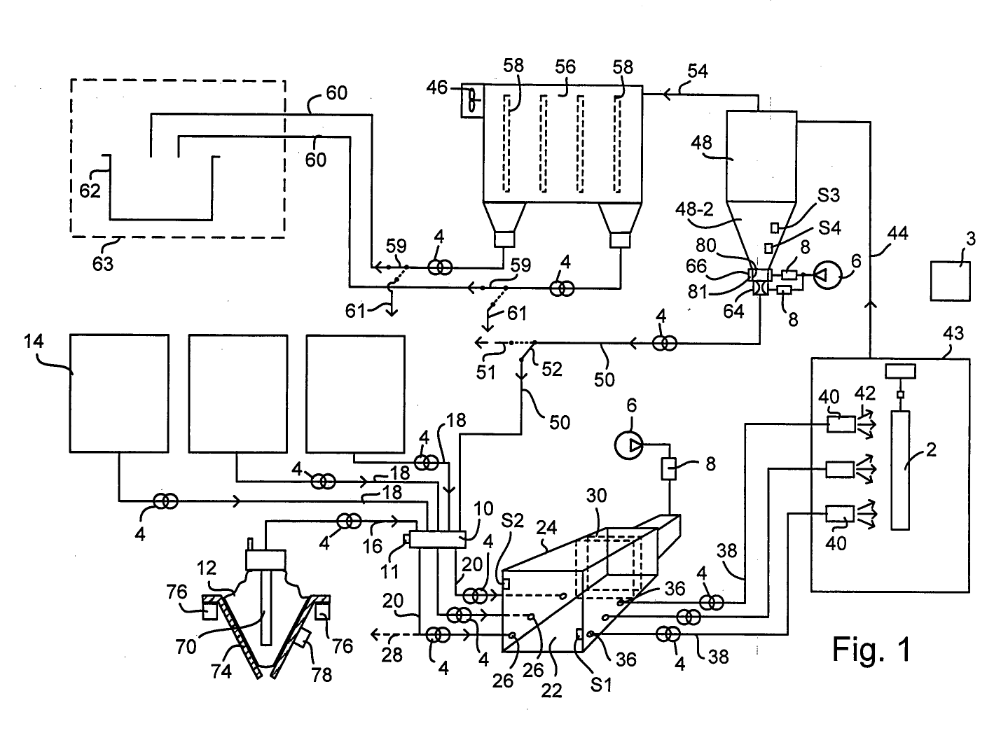

FIG. 1 schematically shows a powder spraycoating facility of the invention that is illustrative of a plurality of various spraycoating facilities to which the invention's powder recovery unit is applicable.

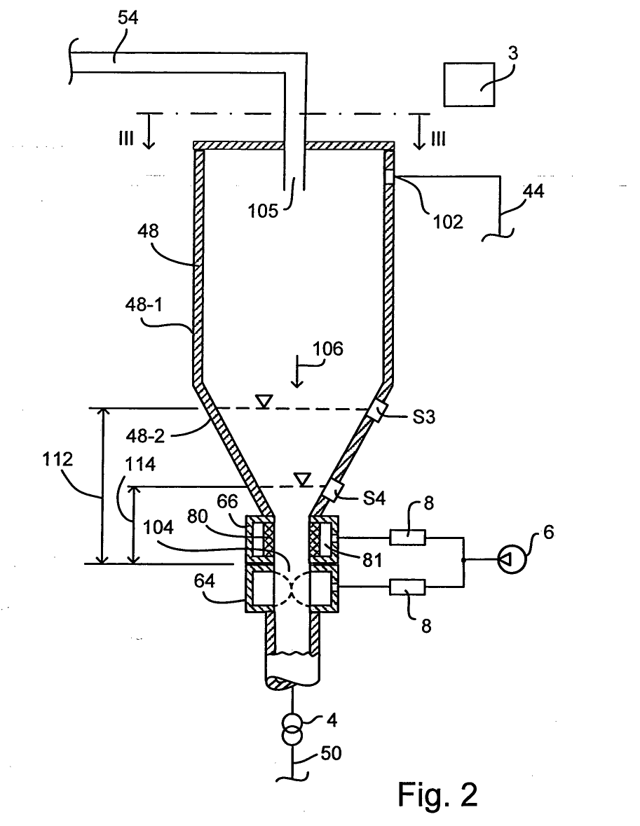

FIG. 2 is a schematic, vertical, axial cross-section of the powder recovery unit of the present invention of FIG. 1 but on an enlarged scale,

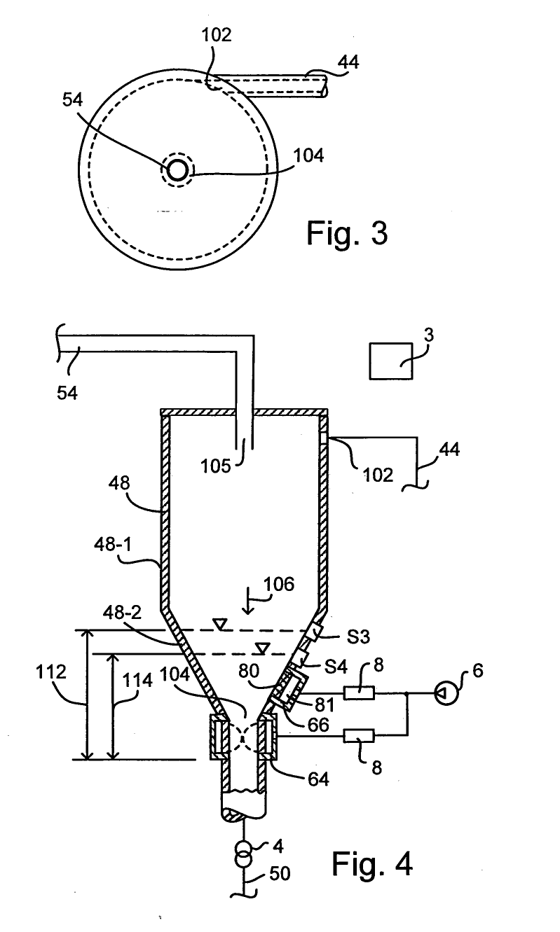

FIG. 3 is a top view of the cyclone separator of FIG. 2, and

FIG. 4 is a partly schematic axial section of another embodiment mode of a powder recovery unit of the present invention.

FIG. 1 schematically shows a preferred embodiment mode of a preferred powder spraycoating facility of the invention to spraycoat objects 2 with coating powder which is subsequently molten in an oven onto said object. One or more electronic control(s) 3 are used to drive the operations of the powder spraycoating facility. Powder pumps 4 pneumatically move the coating powder. Said pumps may be injectors wherein compressed air acting as the conveying air aspirate coating powder from a powder container, whereupon the mixture of conveying air and coating powder jointly flows into a container or toward a sprayer.

Illustratively such injectors are known from the European patent document EP 0 412 289 B1.

The powder pump(s) used may be the kind that sequentially move small doses of powder, each small powder dose (quantity of powder) being stored in a powder chamber and then being expelled by compressed air from the powder chamber. The compressed air remains behind the powder dose and pushes it ahead. Such pumps occasionally are called compressed-air thrust pumps or plug moving pumps because the compressed air pushes the stored powder dose like a plug/stopper before it through a pump outline conduit. Various kinds of powder pumps moving packed coating powder are illustratively known from the following documents: DE 103 53 968 A1; U.S. Pat. No. 6,508,610 B2; US 2006/0193704 A1; DE 101 45 448 A1 and WO 2005/051549 A1.

The invention is not restricted to one of the above cited pump types.

A source of compressed air 6 is used to generate the compressed air to pneumatically move the coating powder and to fluidize it, said source being connected to the various components by corresponding pressure adjusting elements 8 such as pressure regulators and/or valves.

Fresh powder from the manufacturer is fed from a vendor's container—which may be a small container 12, for instance a dimensionally stable container or a bag holding for instance 10 to 50 kg powder, for instance 25 kg, or for instance a large container 14 also dimensionally stable or a bag holding for instance between 100 kg and 1,000 kg powder—by means of a powder pump 4 in a fresh powder conduit 16 or 18 to a sieve 10. The sieve 10 may be fitted with a vibrator 11. Herein the expressions “small container” and “large container” denote both dimensionally stable containers and those which are not, such as flexible bags, unless as otherwise noted.

The coating powder sifted through the sieve 10 is moved by gravity or preferably always by a powder pump 4 through one or more powder feed conduits 20 through powder intake apertures 26 into an intermediate receptacle chamber 22 of a dimensionally stable intermediate receptacle 24. Preferably the volume subtended by the intermediate receptacle 22 is substantially smaller than that of the fresh powder small container 12.

In a preferred embodiment mode of the invention, the powder pump 4 of the minimum of one powder feed conduit 20 leading to the intermediate receptacle 24 is a compressed air pump. In this instance the initial segment of the powder feed conduit 20 may serve as a pump chamber which receives the powder sifted through the sieve 10 as it drops through a valve, for instance a pinch valve. Once this pump chamber contains a given powder portion, the powder feed conduit 20 is shut off from the sieve 10 due to valve closure. Next the powder portion is forced by compressed air through the powder feed conduit 20 into the intermediate receptacle chamber 22.

Preferably the powder intake apertures 26 are configured in a side wall of the intermediate receptacle 24, preferably near the bottom of the intermediate receptacle chamber 22, so that, when compressed-air flushes the intermediate receptacle chamber 22, even powder residues at the bottom can be expelled through the powder intake apertures 26, and for that purpose the powder feed conduits 20 preferably are separated from the sieve 10 and directed into a waste vessel as indicated by a dashed arrow 28 in FIG. 1. The intermediate receptacle chamber 22 is cleaned for instance by a plunger 30 that is fitted with compressed air nozzles and is displaceable through the intermediate receptacle chamber 22.

Powder pumps 4, for instance injectors, are connected to one or more powder outlet apertures 36 to move coating powder through powder conduits 38 to the sprayers 40. The sprayers 40 may be fitted with spray nozzles or rotary atomizers to spray coating powder 42 onto the object 2 to be coated, said object being situated in a coating cabin 43. Preferably the powder outlet apertures 36 are situated in a wall that is opposite the wall containing the powder intake apertures 26. Preferably the powder outlet apertures 36 also are configured near the bottom of the intermediate receptacle chamber 22

Preferably the size of the intermediate receptacle chamber 22 allows storing coating powder in amounts between 1.0 and 12 kg, preferably between 2.0 and 8.0 kg. In other words, the size of the intermediate receptacle chamber 22 preferably shall be between 500 and 30,000 cm³, preferably between 2,000 and 20,000 cm³. The size of the intermediate receptacle chamber 22 is selected as a function of the number of powder outlet apertures 36 and of powder conduits 38 connected to them in a manner to allow continuous spraycoating while also allowing rapidly cleaning the intermediate receptacle chamber 22 during pauses of operation for purposes of powder changes, preferably in automated manner. The intermediate receptacle chamber 22 may be fitted with a fluidizing means to fluidize the coating powder.

Coating powder 42 failing to adhere to the object 2 is aspirated as excess powder through an excess powder conduit 44 by means of a flow of suction air from a blower 46 into a cyclone separator 48. In the cyclone separator, the excess powder is separated as much as possible from the suction flow. The separated powder proportion is then moved as recovery powder from the cyclone separator 48 through a recovery powder conduit 50 to the sieve 10 and from there it passes through said sieve either by itself or admixed to fresh powder, through the powder feed conduits 20 once more, into the intermediate receptacle chamber 22.

Depending on the kind of powder and/or the intensity of powder soiling, the powder recovery conduit 50 also may be separated from the sieve 10 and the recovery powder may be moved into a waste vessel as schematically indicated by a dashed line 51 in FIG. 1. In order that the powder recovery conduit 50 need not be separated from the sieve 10, it may be fitted with a switch 52 allowing connecting it either to the sieve 10 or to a waste vessel.

The intermediate receptacle 24 may be fitted with one or more sensors, for instance two sensors S1 and/or S2 to control feeding coating powder into the intermediate receptacle chamber 22 by means of the control 3 and the powder pumps 4 in the powder feed conduits 20. Illustratively the lower sensor S1 detects a lower powder level limit and the upper sensor S2 detects an upper powder level limit.

The lower end segment 48-2 of the cyclone separator 48 can be designed and used as a recovery powder supply bin and be used as such and be fitted for that purpose with one or several illustratively two sensors S3 and/or S4 which are operationally connected to the control 3. As a result the fresh powder feed through the fresh powder feed conduits 16 and 18 may be blocked, especially in automated manner, until enough recovery powder shall accumulate in the cyclone separator 48 to feed through the sieve 10 enough recovery powder into the intermediate receptacle chamber 22 for spraycoating by the sprayer 40. Once the recovery powder becomes insufficient in the cyclone separator 48 for such operation, the switchover to the fresh powder feed through the fresh powder conduits 16 or 18 may automatically kick in. The invention also offers the possibility to simultaneously feed fresh and recovery powders to the sieve 10 to mix them.

The exhaust air of the cyclone separator 48 passes through an exhaust air conduit 54 into a post filtration system 56 and therein through one or more filter elements 58 to arrive at the blower 46 and beyond latter into the atmosphere. The filter elements 58 may be filter bags or filter cartridges of filter plates or similar elements. Ordinarily the powder separated from the air flow by means of the filter elements 58 is waste powder and drops by gravity into a waste vessel, or, as shown in FIG. 1 it may be moved by means of one or several waste conduits 60 each fitted with a powder pump 4 into a waste vessel 62 at a waste station 63.

Depending on the kind of powder and on the powder coating conditions, the waste powder also may be recovered and moved to the sieve 10 in order to be recirculated into the coating circuit. This feature is schematically indicated in FIG. 1 by switches 59 and branch conduits 61 of the waste conduits 60.

Typically only cyclone separators 48 and the post filtration system 56 are used for multicolor operation, wherein different colors each are sprayed only for a short time, and the waste powder of the post filtration system 56 is moved into the waste vessel 62. In general the powder-separating efficiency of the cyclone separator 48 is less than that of the post filtration system 56, but cleaning is more rapid than in the post filtration system 56. As regards monochrome operation, wherein the same powder is used for a long time, the cyclone separator 48 may be dispensed with, and the excess powder conduit 44 instead of the exhaust air conduit 54 may be connected to the post filtration system 56, and the waste conduits 60—which in this instance contain recovery powder—act as powder recovery conduits to the sieve 10. Typically the cyclone separator 48 is used in combination with the post filtration system 56 in monochrome operation only when the coating powder entails problems. In such eventuality only the recovery powder of the cyclone separator 48 is moved through the powder recovery conduit 50 to the sieve 10 whereas the waste powder of the post filtration system 56 is moved into the waste vessel 62 or into another waste vessel, said waste vessel being optionally free of waste conduits 60 and directly positioned underneath an outlet aperture of the post filtration system 56.

The lower end of the cyclone equipment 48 may be fitted with an outlet valve 64, for instance a pinch valve. Moreover fluidizing means 66 to fluidize the coating powder may be configured above said outlet valve 64, in or at the lower end segment 48-2, constituted as a supply bin of the cyclone separator 48. The fluidizing means 66 contains at least one fluidizing wall 80 made of material comprising open pores or fitted with narrow boreholes, this material being permeable to compressed air but not to the coating powder. The fluidizing wall 80 is situated between the powder path and a fluidizing compressed air chamber 81. The fluidizing compressed air chamber 81 may be connected by a compressed air adjusting element 8 to the compressed air source 6.

For the purpose of aspirating fresh coating powder, the fresh powder conduit 16 and/or 18 may be connected to allow powder flow at is upstream end either directly or through the powder pump 4 to a powder feed pipe 70, said pipe being dippable into the manufacturer's container 12 or 14. The powder pump 4 may be mounted at the beginning of, the end of, or in-between, in the fresh powder conduit 16 or 18 or at the upper or lower end of the powder feed pipe 70.

A small fresh powder container in the form of a fresh powder bag 12 is shown in FIG. 1 held in a bag-receiving hopper 74. The bag-receiving hopper 74 keeps the powder bag 12 in a specified shape, the bag opening being at the upper bag end. The bag-receiving hopper 74 may be mounted on a scale or on weighing sensors 76. Such a scale or weighing sensors depending on their design may generate visual displays and/or electrical signals that, following subtraction of the weight of the bag-receiving hopper 74, will correspond to the weight and hence the quantity of the coating powder in the small container 12. Preferably a minimum of one vibrator 78 is mounted at the bag-receiving hopper 74 to shake it.

Two or more small containers 12 may be configured each in a bag-receiving hopper 74, also two or more large containers 14 operating alternately. This feature allows rapidly changing from a small container 12 to another or to one large container 14.

The invention may be modified in a number of ways without restricting it. For instance the sieve 10 may be integrated into the intermediate receptacle 24. Alternatively the sieve 10 may be omitted when the fresh powder quality is high enough. In that case a separate sieve may be used to sift the recovery powder of the conduits 44 and 50, illustratively upstream or downstream of the cyclone separator 48 or in it. Again, sifting the recovery powder will not be required when its quality is adequate for re-use.

A particular embodiment of the cyclone separator 48 is shown on an enlarged scale in FIGS. 2 and 3 relative to the scale of FIG. 1. In addition to being appropriate for the powder spraycoating facility of FIG. 1, this special embodiment also is applicable to other kinds of powder spraycoating facilities. In this special embodiment, the cyclone separator 48 comprises in its upper segment the actual cyclone section 48-1 separating the recovery powder from the powder-air mixed flow of the excess powder conduit 44 by the cyclone effect, and it further comprises the lower end segment 48-2 acting as a supply container or reservoir of recovery powder and denoted hereafter as the supply bin 48-2. At or near its upper end, the peripheral/circumferential wall of the cyclone section 48-1 is fitted with a substantially tangential powder intake 102 connected to the downstream end of the excess powder conduit 44. An airflow outlet 105 which is optionally constituted by the upstream end of the exhaust air conduit 54 or connectable to said conduit 54 is configured at the radial center of the cyclone section 48-1. The supply bin 48-2 is constituted by a downward-pointing extension of the cyclone section 48-1 and is fitted at its lower end with a powder outlet 104. The powder outlet 104 is fitted with the powder outlet valve 64, preferably a pinch valve, by means of which the powder outlet 104 may be alternatingly opened or closed. When viewed in horizontal cross-section, the cyclone section 48-1 is circular.

The powder-air mixture of the excess powder conduit 44 flowing tangentially through the powder intake 102 is divided in the cyclone section 48-1, by centrifugal forces, into recovery powder which due to gravity and the centrifugal forces drops downward into the supply bin 48-2, and into an airflow from the exhaust air blower 48-2 that flows into the exhaust air conduit 54 and that shall contain a minimum of residual powder or none at all. In this manner recovery powder can be stored in the supply bin 48-2 when the powder outlet valve 46 is closed, this recovery powder being separated in the cyclone section 48-1 from the powder-air mixed flow.

In the present invention, the powder passage 106 from the upper cyclone section 48-1 to the supply bin 48-2 below it is devoid of steps/offsets and devoid of powder blocking elements while nevertheless being powder-tight relative to the atmosphere.

The cyclone section 48-1 ands the supply bin 48-2 may be in the form of an integral housing or they be in the form of two mutually affixed housings.

The cyclone section 48-1 may taper conically down like a funnel or it my be right cylindrical over its entire height as shown in FIG. 2. The supply bin 48-2 can be right cylindrical over its full height or preferably as shown in FIG. 2 be conically tapering downward like a hopper, the cross-sectional area of the supply bin 48-2 at the upper bin end being the same as the cross-sectional area of the lower end of the cyclone section 48-1.

A fluidizer 66 is configured preferably in the above cited manner in the lower part of the supply bin 48-2 near the powder outlet valve 64 to fluidize the recovery powder in this supply bin 48-2. The fluidizer 66 may enter the supply bin 48-2 or preferably it may be designed in a manner that the fluidizing wall 66 constitutes at least a portion of the wall of the supply bin 48-2, for instance, as indicated in FIG. 2, being a downward extending cylindrical extension of the funnel-like wall of the supply bin 48-2 or being a portion of such a wall.

As shown in FIG. 4, the fluidizing wall 66 moreover may constitute a peripheral element or the entire periphery of the funnel-like supply bin 48-2 at its lower end.

Herein the expression “fluidization” means the fluidizing compressed air flows through the recovery powder which thereby becomes flowable (fluidized) or more fluid.

In another special embodiment of the invention, the supply bin 48-2 is fitted with at least one or two or more sensors S3 and/or S4. These may be level sensors or switches generating as signal depending on whether the recovery powder in the supply bin 48-2 has reached or not the powder level monitored by the particular sensor. Illustratively one sensor S3 is configured at a height 112 and another sensor S4 illustratively at a height 114 above the powder outlet valve 64, the sensor S3 being higher than the sensor S4. The two sensors S3 and S4 may be used to define a predetermined reserve/store of recovery powder.

Using one or several sensors S3 and/or S4 allows driving, by means of the control 3, the powder outlet valve 64 as a function of a signal from one and/or the other sensors S3 and/or S4. If desired, the powder outlet valve 64 also may be driven by the control 3 as a function of other criteria, for instance whether the sensor S1 of the intermediate receptacle 24 transmits a “power needed” signal and/or depending on the sensors or weighing cells 76, namely whether there is or not sufficient fresh powder in the fresh powder container 12.

The powder outlet valve 64 preferably shall be open only when recovery powder is removed from the supply bin 48-2 whereas this powder outlet valve preferably always shall remain closed when no powder is being removed from the cyclone separator 48. In this manner air is precluded from getting into the cyclone separator 48 and from interfering with the cyclone operation and/or reducing the capacity of the supply bin.

In one embodiment mode, opening the powder outlet valve 64 allows the recovery powder to drop by gravity onto the sieve 10. In the preferred embodiment mode of the invention, which is shown in the drawings, the powder recovery conduit 50 is connected to the outlet side of the powder outlet valve 64. Preferably a powder pump 4 is configured in the powder recovery conduit 50 and in especially preferred manner it is configured at said conduit's upstream or its downstream end, to move recovery powder from the supply bin 48-2 to the sieve 10.

In one preferred embodiment mode of the invention, said powder pump 4 is turned ON by a control 3 only when the powder outlet valve 64 is also being opened by said control 3. This feature precludes, depending on the kind of powder pump 4, that compressed air be aspirated by it from the cyclone separator 48 or be moved into it and that thereby said cyclone separator might malfunction.

1. A powder spraycoating facility's powder recovery unit comprising a cyclone separator fitted with a powder intake admitting a powder-air mixed flow, further with a powder outlet to discharge recovery powder from the mixed flow, and with an air flow outlet to discharge air from the mixed flow;
characterized in that the cyclone separator comprises a cyclone section fitted with the powder intake and is designed to separate recovery powder from the mixed flow by cyclone action; in that the cyclone separator comprises a supply bin in the form of a downward extension of the cyclone section and is fitted at its lower end with the powder outlet; that the powder outlet is fitted with a powder outlet valve in a manner that when this powder outlet valve is closed, recovery powder separated by the cyclone effect from the mixed flow may be stored in the supply bin; where a powder passage is provided from the cyclone section into the supply bin, said passage being devoid of powder blocking elements but being powder-tight relative to the atmosphere.

2. Powder recovery unit as claimed in claim 1, characterized in that the powder outlet valve is a pinch valve.

3. Powder recovery unit as claimed in claim 1, characterized in that it comprises a fluidizer to fluidize recovery powder in the supply bin above the powder outlet valve and near the powder outlet valve.

4. Powder recovery unit as claimed in clam 3, characterized in that the fluidizer comprises at least one fluidizing wall between the inside space of the supply bin and a fluidizing chamber, the fluidizing wall being fitted with a plurality of open pores or boreholes so small that they are permeable to fluidizing air but impermeable to the recovery powder particles.

5. Recovery powder unit as claimed in claim 3, characterized in that the minimum of one fluidizing wall constitutes a portion of the container wall forming the supply bin.

6. Powder recovery unit as claimed in claim 1, characterized in that the supply bin is fitted with at least one sensor detecting at least one predetermined powder level in the supply bin.

7. Powder recovery unit as claimed in claim 1, characterized in that the supply bin is fitted with at least two sensors configured at different heights to detect a number of different predetermined powder levels in the supply bin which corresponds to the number of sensors.

8. Powder recovery unit as claimed in claim 6, characterized in that a control is used which is operationally connected to the minimum of one sensor and to the powder outlet valve and drives this powder outlet valve as a function of at least one signal from the minimum of one sensor.

9. Powder recovery unit as claimed in claim 1, characterized in that a powder pump is configured downstream of the powder outlet valve in a powder outlet path to move recovery powder out of the supply bin.

10. Powder recovery unit as claimed in claim 9, characterized by a control which is operationally connected to the powder pump and to the powder outlet valve and drives them in a manner that the powder pump is turned ON when the powder outlet valve is open and is turned OFF when the powder outlet valve is closed.
